(19) United States
(12) Patent Application Publication
(10) Pub. No.: US 2014/0196556 A1
(43) Pub. Date: Jul. 17, 2014

(54) PARALLEL SHIFT TRANSMISSION

(71) Applicants: Stefan Beck, Eriskirch (DE); Martin Fellmann, Friedrichshafen (DE); Matthias Reisch, Ravensburg (DE)

(72) Inventors: Stefan Beck, Eriskirch (DE); Martin Fellmann, Friedrichshafen (DE); Matthias Reisch, Ravensburg (DE)

(73) Assignee: ZF Friedrichshafen AG, Friedrichshafen (DE)

(21) Appl. No.: 14/118,708

(22) PCT Filed: Mar. 20, 2012
(86) PCT No.: PCT/EP2012/054877

§ 371 Date: Nov. 19, 2013

(30) Foreign Application Priority Data
May 24, 2011 (DE) 10 2011 076 391.0

(51) Int. Cl. F16H 3/093

(52) U.S. Cl. CPC F16H 3/093
USPC 74/331

(57) ABSTRACT

A parallel shift transmission which comprises split and range groups, each of which is divided into two parallel transmission branches. One branch can be actuated by a load shift element to transfer rotation of a drive shaft, via a transmission ratio of the split group, and then to a countershaft of the associated branch. Subsequently rotation can be converted, via a range ratio of the range group, into rotation of an output drive shaft. The gear stages are alternately divided between the branches in the order of associated transmission ratios, while each of the range ratios is achieved by shifting one of the group stages of the range group. To drive a power take-off via the transmission, the load shift elements are individual clutches, each of which is arranged in the associated branch between an output-side counter shaft of the split group and a drive-side counter shaft of the range group.

This application is a National Stage completion of PCT/EP2012/054877 filed Mar. 20, 2012, which claims priority from German patent application serial no. 10 2011 076 391.0 filed May 24, 2011.

### FIELD OF THE INVENTION

The present invention relates to a parallel shift transmission for a motor vehicle, in particular for an agricultural or municipal utility vehicle, the parallel shift transmission comprises a split group and a range group, each of which is divided into two parallel transmission branches, wherein one of the transmission branches can be selected by actuating one respectively corresponding load shift element so that rotational movement of a drive shaft can be transferred with one of a plurality of transmission ratios of the split group, transmitted to countershafts according to the selection of one of the transmission branches, and so that the rotational movement of the drive shaft can in the further course be converted into rotational movement of an output drive shaft, being transmitted with one of a plurality of range ratios of the range group, wherein each of the transmission ratios is defined by shifting a correspondingly associated gear stage of a plurality of gear stages of the split group, which are alternately distributed to the two transmission branches in a sequence of the corresponding transmission ratio, and each of the range ratios is determined by shifting a correspondingly associated group stage of a plurality of group stages of the range group.

### BACKGROUND OF THE INVENTION

In agricultural machinery, transmissions need to represent very different driving ranges due to the very broad field of tasks of agricultural utility vehicles, such as field work or transport activities, a need which necessitates a correspondingly large spread between the slowest and fastest gear stages. Agricultural machinery transmissions also normally require small geometric step changes between the single gear stages, so as to realize a high number of gears in combination with the large spread. Such a high number can be attained through a group design of an agricultural machinery transmission with a reasonable effort.

Herein, an agricultural machinery transmission normally comprises a stage group or main group, an upstream or downstream split group, a normally downstream range group, and, in many instances, a reverse group. The main group here constitutes a gear path for the transmission, which is correspondingly transmitted through the other upstream and downstream transmission groups and the respective stages thereof. The upstream or downstream split group compresses the gear path of the main group, by dividing the gear stages of the main group through the small step changes of the split group and therefore multiplying the number of gears by the number of available stages of the split group. A downstream range group, however, expands the gear path, and the gear stages of the main transmission part are transmitted over large transmission changes into different transmission ranges. Changes of the direction of rotation can then be implemented through the reverse group that is typically also provided, and can be realized in combination with the other transmission groups of likely a plurality of reversal gears,

In some agricultural machinery, though, only one split group may be provided, which unites the functions of a traditional split group and of a main group and downstream of which is a range group then provided, in the further course. These transmissions are then, inter alia, implemented so as to allow load shifting within a group as well, so as to make it possible to change gears within each of the groups during operation of the respective agricultural machinery without interrupting the traction. One common design for this is a so-called parallel shift transmission, in which the capability for load shifting is provided by switching between two transmission branches corresponding to the actuation of associated load shift elements.

DE 10 2007 000 595 A1 provides a parallel shift transmission which is composed of a split group and a range group. The split group and the range group are divided into two parallel transmission branches thereby, wherein each of the transmission branches is selected by the actuation of a correspondingly associated load shift element. The two load shift elements are combined into a double clutch herein which transfers rotary motion of a drive shaft of the parallel shift transmission to one of two input shafts of the split group depending on the operation, wherein this rotary motion is then transferred to a respective parallel-running counter shaft of the two transmission branches on the basis of the respectively selected input shaft corresponding to a selection of one of a plurality of gear stages of the split group with a corresponding transmission ratio. This rotary motion that is transmitted in the reduction gear is then transferred with a selected range ratio of the range group to an output drive shaft of the parallel shift transmission in the further course, wherein the respectively selected range ratio is defined by shifting an associated group stage of the range group.

The gear stages of the split group are distributed alternately to the two transmission branches in the order of the respective transmission ratios thereof so that sequentially shifting the single transmission ratios always changes back and forth between the two transmission branches. It is accordingly possible to preselect the respective gear stage in the currently free transmission branch even before shifting to the next corresponding transmission ratio, due to the respective idler gears of the associated gearwheel stage having already been coupled via shift elements to the corresponding shafts so that only one gear change in the dual clutch must be carried out for the final shifting. A change in the transmission ratio can thus be carried out under load and therefore without interrupting traction.

The single group stages of the subsequent range group, meanwhile, can be produced on the two transmission branches by the ability to transmit the rotary motion to the output drive shaft from the two reduction gears each having the corresponding gearwheel pairs. This configuration makes it possible to shift from a last gear stage of a group stage to a first gear stage of the following group stage under load, so as to form, overall, a fully load-shiftable parallel shift transmission. Herein, there is no gear in which more than two toothed meshings operate under load, resulting in a very high efficiency for the parallel shift transmission.

### SUMMARY OF THE INVENTION

On the basis of the above-described prior art, the objective of the present invention is to provide a parallel shift transmission of the generic kind which makes it possible to feed through a power take-off of a drive machine of a respective utility vehicle with little effort. The present invention seeks overall to achieve a very high efficiency of the parallel shift transmission.

According to the present invention, a parallel shift transmission of a utility vehicle comprises a split group and a range group, wherein the parallel shift transmission preferably relates to a transmission of an agricultural or municipal utility vehicle, for example, a tractor. The split group and the range group are herein divided into two parallel transmission branches, one of which can be selected by operation of a respectively associated load switch element. Depending on the selection of one of the transmission branches, rotary motion of a drive shaft is transmitted with one of a plurality of transmission ratios of the split group to a counter shaft of the respective selected transmission branch and, in the further course, is transmitted with one of a plurality of range ratios of the range group into rotary motion of an output drive shaft. Each of the transmission ratios is herein defined by shifting of a respectively associated gear stage of a plurality of gear stages of the split group, wherein the gear stages are distributed alternately to the two transmission branches in the order of the respectively associated transmission ratios. In the range group, each of the range ratios is set by shifting to one of the respectively associated group stages of a plurality of group stages.

The gear stages of the split group and the group stages of the range group are herein each realized in particular as spur gear stages, which are each composed of a fixed gear arranged on a shaft, and an idler gear that meshes with the fixed gear and is rotatably mounted on a respective other shaft. By means of an associated shift element, the respective idler gear can then be non-rotatably coupled to the respective shaft, wherein the respective shift element herein is realized as both a friction-locking shift element, in particular as a multi-disc clutch, or, preferably, as a form-locking shift element, in particular in the form of a locking synchronization or a claw clutch. In the case of an embodiment as a claw clutch, a central synchronization unit is provided on the respective shaft, for example, in the form of a multi-disc brake or a band brake, or even an electrical machine. Furthermore, according to the present invention, in particular form-locking shift elements of two axially adjacent spur gear stages are combined into a shared shift packet, a respective coupling element thereof connecting, in a form-locking manner, either the one or the other idler gear to the respective shaft bearing the shift packet, from a neutral position. It is additionally conceivable to design a portion of the shift elements of the split group and/or of the range group, one to be form-locking shift elements and the other to be friction-locking shift elements. Likewise, it would be possible also to use only form-locking shift elements with one group and only force locking shift elements with the other group. Finally, according to the present invention, the drive shaft and the output drive shaft can be arranged either coaxially, or parallel and offset, to one another.

The present invention thus comprises the technical teaching of designing the load switching elements as single clutches which are respectively arranged in the associated transmission branch between an output-side counter shaft of the split group and a drive-side counter shaft of the range group. In other words, the load switching elements are thus placed as single clutches between the split group and the range group and therein between counter shafts of the respectively associated transmission branches. According to actuation of the respective single clutches, then, a power flow is realized over the respective transmission branch through coupling of the two counter shafts.

Such an embodiment has the advantage of enabling low-effort implementation of a power take-off of a drive machine of the respective utility vehicle, which, for example, is fed through the transmission to produce a power take-off, because no feed-through needs to be implemented through load shift elements that are placed there, as with a dual clutch, in the region of the drive shaft of the transmission. Moreover, the placement of the load shift elements between the counter shafts of the transmission branches achieves a reduction of the mass inertia in comparison to a drive-side placement, so that shift elements in the region of the counter shafts can be of considerably smaller dimensions, because less friction is required to couple the respective idler gear to the shaft. Finally, the placement of the load shifting elements as in the present invention makes it possible to allocate a reduction gear to each of the transmission branches so that the gear stages of the split group can also be arranged so as to be sorted with respect to the counter shafts. Accordingly, only by shifting from gear stages associated with one transmission branch can the one reduction gear be brought into the power flow through corresponding actuation of the load shifting elements, and only shifting of the other gear stages associated with the other transmission branch can do the same to the other reduction gear parallel thereto.

In the scope of the present invention, the individual clutches are herein configured as shared friction locking clutches and can designed, depending on the torque to be transmitted, as dry-running or wet-running clutches or similar suitable types of clutches.

According to an advantageous embodiment of the present invention, gear stages of the split group are arranged in the axial direction by pairs in one plane, by assigning a shared fixed gear to one gear stage associated with one transmission branch and to one gear stage that is adjacent thereto and associated with the other transmission branch. The arrangement of two gear stages in one axial plane makes it possible to significantly reduce the structural length of the transmission. An arrangement of each of the adjacent gear stages pairwise in one plane causes the gear stages to have similar tooth widths at all times, so that a shared fixed gear can be provided without problem. The fixed gear then meshes with two idler gears, one of which is provided on a counter shaft of one transmission branch and the other of which is provided on a counter shaft of the other transmission branch.

According to an alternative or supplementary embodiment of the present invention, at least the gear stages of the split group are placed separately in one plane with a respective high transmission ratio in the axial direction. Such an arrangement has the advantage of making it possible to thereby place the two reduction gears of the transmission branches closer together. This is because, on the basis of the arrangement of gear stages with a high transmission ratio in separate axial planes, even a denser placement on the respective other reduction gear does not allow for the idler gears of these gear stages to come unintentionally into contact with an idler gear lying at the same axial height. Further combining of the reduction gears, however, makes it possible to design smaller gearwheels for rotary direction reversal device optionally provided in the respective reduction gear, and therefore to minimize the expenditure in this region. Herein, the axial offset can be produced via individual fixed gears, which are sequential in the axial direction, or also via an individual fixed gear extending in the axial direction, wherein the latter is then meshed with two idler gears which are sequential in the axial direction. Depending on the depicted transmission ratios and subject to an optionally present rotary direction reversal device, either a pairwise or individual arrangement of gear stages, or both variations, can be used in the split group.

In further development of the present invention, each of the gearwheel pairs of at least one group stage of the range group for the two transmission branches is arranged lying in the axial direction on one shared plane, wherein a shared fixed gear is assigned to the gearwheel pairs. This measure also allows for length in the region of the group stage to be spared, in that one group stage has only one fixed gear which then meshes with two idler gears on the respective counter shafts of the two transmission branches. Alternatively or additionally hereto, each of the gearwheel pairs of at least one group stage is placed separately on each of the transmission branches in the axial direction on a respective plane. Preferably, idler gears of the gearwheel pairs are arranged on the output drive shaft. The placement of the gearwheel pairs of one group stage in separate planes therefore makes it possible for the reduction gears to again be placed closer together in a group stage, with a high range ratio, without the two idler gears of the respective group stages unintentionally coming into contact with one another. This offset in the axial direction can be represented herein similarly to with the split group on two fixed gears that are sequential in the axial direction or one fixed gear correspondingly extending in the axial direction, wherein the latter is then meshed with two idler gears which are sequential in the axial direction. With high output drive shaft rotational speeds and high range group ratios, overly high idler gear speeds can be avoided by means of the placement of the idler gears of the gearwheel pairs on the output drive shaft.

In a further development of the present invention, parallel counter shafts for reversal of direction of rotation can be coupled to one another via individual gearwheel pairs by actuating associated shifting elements. This coupling then connects a counter shaft of one transmission branch on the output side of the split group to a parallel counter shaft of the other transmission branch on the drive side of the range group. By means of such an embodiment, the direction of rotation can be reversed in the parallel shift transmission according to the present invention with only one additional tooth engagement, by transmission of rotary motion of a counter shaft of one transmission branch, via one of the intermediate gearwheel pairs, to a parallel-lying counter shaft of the other transmission branch. Because of the only one additional tooth engagement, the efficiency herein deteriorates only slightly in comparison with a forward travel with two tooth engagements that are under load. Furthermore, depending on the arrangement of the switching elements in the power flow direction, a capability for load shifting in reverse speeds can be achieved, so that a reversal, under load, of the respective utility vehicle, i.e., a switch between forward and reverse motion, is possible. The arrangement of the switching elements between the load shift elements and the respective gearwheel pair in the power flow direction from the drive shaft to the output drive shaft allows for this initiation of a reversal in the direction of rotation under load. Also, providing the gearwheel pairs compactly between the counter shafts makes it possible to integrate a device for reversal of the direction of rotation in a parallel shift transmission as in the present invention without having to provide a separate reversal group with optional additional load shift elements. The gearwheel pairs can be placed either in the range of the gear stages or in the range of the group stages so as to be integrated into the split group or the range group.

According to another advantageous embodiment of the present invention, a crawler gear group is provided, by means of which rotary motion can be transmitted from an input shaft via a first crawler gear stage to a parallel counter shaft, and from the counter shaft, by means of a second crawler gear stage, to an output shaft. Preferably, the crawler gear group comprises a shift packet, via which either the input shaft can be coupled directly to the output shaft that runs coaxially to the input shaft, or a power flow can be implemented via the two crawler gear stages. Preferably, the input shaft pertains to the drive shaft of the parallel shift transmission or the output shaft pertains to the output drive shaft of the parallel shift transmission. Providing a crawler gear group enables extreme reduction of the drive shaft rotational speed in order to slow down the utility vehicle, for example, for usage in rough terrain or in certain work tasks. The crawler gear group can either be upstream of the split group and the range group, in which case the drive shaft represents the input shaft of the crawler gear group, or can be downstream of the split group and the range group, in which case an output shaft of the crawler gear group is simultaneously the output drive shaft.

The present invention is not limited to the specified combination of features of the main claim or dependent claims. This results moreover in the possibility of combining individual features, including those arising from the claims, the following description of the embodiments, or directly from the drawings. That the claims reference the drawings through the use of reference numerals is not intended to limit the scope of the claims.

### BRIEF DESCRIPTION OF THE DRAWINGS

Additional advantageous embodiments of the present invention will also be apparent from the following description of preferred embodiments of the present invention which make reference to the figures shown in the drawings. Shown therein are:

FIG. 1 is a schematic representation of a parallel shift transmission according to the present invention, according to a first preferred embodiment of the present invention;

FIG. 2 is a schematic front-end view of the parallel shift transmission according to FIG. 1;

FIG. 3 is a shifting matrix of the parallel shift transmission according to FIG. 1;

FIG. 4 is a schematic representation of a parallel shift transmission according to the present invention, according to a second preferred embodiment of the present invention;

FIG. 5 is a schematic representation of a parallel shift transmission according to the present invention, according to a third preferred embodiment of the present invention; and

FIG. 6 is a schematic representation of a parallel shift transmission according to the present invention, according to a fourth preferred embodiment of the present invention.

### DETAILED DESCRIPTION OF THE PREFERRED EMBODIMENTS

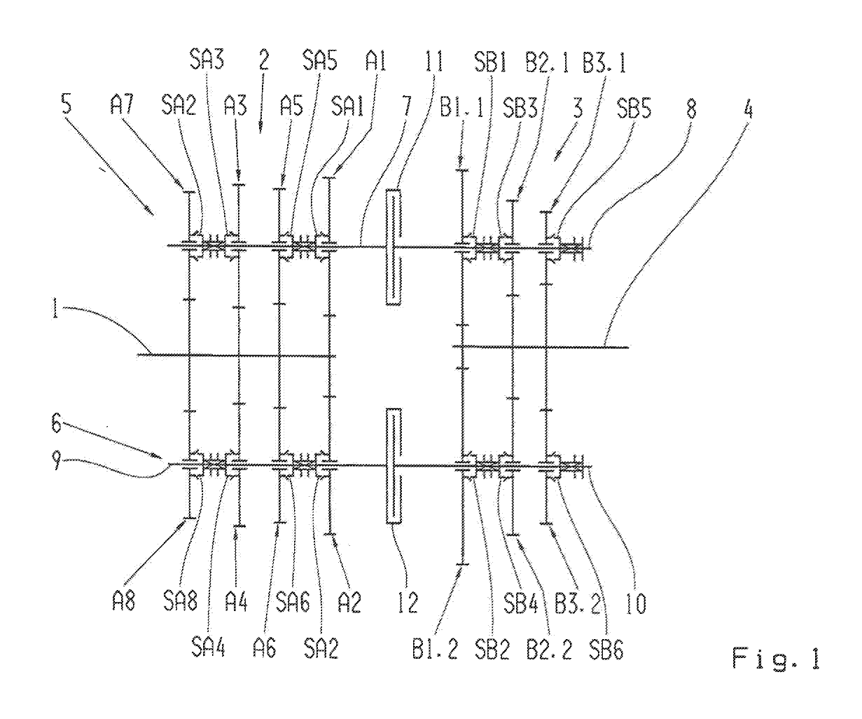

FIG. 1 illustrates a schematic representation of a parallel shift transmission according to the present invention, according to a first preferred embodiment of the present invention, wherein this transmission preferably pertains to the transmission of a municipal or agricultural utility vehicle. The parallel shift transmission is provided with a drive shaft 1 which is coupled to a drive motor of the respective utility vehicle and accordingly rotates with the rotational speed of the drive motor during the operation of the utility vehicle. Rotary motion of the drive shaft 1, can then be transferred to an output drive shaft 4, transmitted via an intermediate split group 2 and an intermediate range group 3. The output drive shaft 4 is then connected, in the further course, to other components of a drive train of the utility vehicle.

The split group 2 and the range group 3 are thus divided into two parallel transmission branches 5 and 6, wherein each of the transmission branches 5 and 6 is provided with associated counter shafts 7 and 8 or 9 and 10. The counter shafts 7 and 9 are herein positioned on the output side of the split group 2 while the counter shafts 8 and 10 are positioned on the drive side of the range group 3, wherein a load switching element in the form of a single clutch 11 or 12, respectively, is provided between the respective output-side counter shafts 7 or 9 and the respective drive-side counter shafts 8 or 10. These single clutches 11 and 12 are herein designed to be friction locking clutches, in particular in the form of dry-running or wet-running clutches, and, when actuated in the respective transmission branches 5 and 6, connect the respective output side of the split group 2 to the respective drive side of the range group 3 by coupling of the respective counter shafts 7 and 8 or 9 and 10.

On the drive side of the split group 2, the drive shaft 1 carries four axially consecutive fixed gears, each of which meshes with two idler gears that are rotatably supported on the counter shafts 7 and 9 running parallel thereto. Herein each of the fixed gears placed on the drive shaft 1, together with each of the idler gears rotatably supported on the respective counter shafts 7 or 9, forms one of the gear stages A1 to A8. As will also be understood from FIG. 1, all of the idler gears of the odd-numbered gear stages A1, A3, A5, and A7 are thereby arranged on the counter shaft 7 of the transmission branch 5 and all of the idler gears of the even-numbered gear stages A2, A4, A6, and A8 are thereby arranged on the counter shaft 9 of the transmission branch 6. A respective transmission ratio of the gear stages A1 to A8 thereby diminishes along the series A1 to A8 with each of the geometric step changes, so that the gear stages A1 to A8 are alternately distributed to the two transmission branches 5 and 6 in the order of the respectively associated transmission ratios. This has the consequence that with a consecutive shifting of the single gear stages A1 to A8 a shifting back and forth between the two transmission branches 5 and 6 always occurs.

As can be further derived from FIG. 1, the gear stages A1 to A8 are each arranged in the axial direction, lying in a plane. Thus, the idler gears of the gear stages A1 and A2, of the gear stages A3 and A4, of the gear stages A5 and A6, and of the gear stages A7 and A8 lie in one axial plane and each are in meshed engagement with the intermediate fixed gear. Accordingly, gear stages that are adjacent to one another with respect to a shifting sequence are always arranged in one plane so that these pairs have similar tooth widths and therefore also similar required widths for a fixed gear. The pairwise combination in one axial plane makes it possible to substantially shorten the axial extension of the split group 2.

To shift each of the gear stages A1 to A8, the respectively associated idler gears can now be non-rotatably coupled via shift elements SA1 to SA8 to the respective counter shafts 7 or 9. The shift elements SA1 to SA8 are then each combined in pairs into shift packets, with which a respective coupling element of the shift packets can non-rotatably connect one of the associated idler gears to the respective counter shaft 7 or 9 from a neutral position.

In the further course, during operation of the respectively associated single clutch 11 and 12, rotary motion of the counter shaft 7 or 9 is then transferred, in the corresponding transmission branch 5 or 6, to the counter shafts 8 or 10, respectively, extending coaxially thereto, by the coupling of the counter shafts 7 and 8 or 9 and 10, respectively, to each other through the single clutches 11 or 12, respectively. This rotary motion is then transferred to the output drive shaft 4, transmitted from the respective counter shafts 8 or 10, respectively, through the selection of one of a plurality of range ratios of the range group 3. To represent the single range ratios, the range group 3 is provided with a plurality of group stages B1.1 to B3.2, wherein B1.1 and B1.2, B2.1 and B2.2, and B3.1 and B3.2 each form a group stage of the range group 3 and are arranged in the axial direction in a shared plane, wherein the same are each provided with a shared fixed gear that is placed on the output drive shaft 4. Herein, in the group stage pairs B1.1 and B1.2, B2.1 and B2.2, and B3.1 and B3.2, the respective idler gears are identically designed so that these pairs represent an identical range ratio of the respective counter shafts 8 or 10 on the output drive shaft 4. By means of the pairwise arrangement in respective axial planes, the range group 3 can also be implemented very compactly in the axial direction.

To shift the single group stages B1.1 to B3.2, respectively associated shift elements SB1 to SB6 are placed on the respective counter shafts 8 or 10, via which shift elements the respectively associated idler gear is non-rotatably coupled to the respective counter shaft 8 or 10, and therefore rotary motion of the counter shaft 8 or 10 can be transferred to the output drive shaft 4 with the respectively associated range ratio. The shift elements SB1 to SB4 are herein respectively combined by pairs into shift packets, the respective coupling elements of which can non-rotatably connect one of the associated idler gears to the respective counter shaft 8 or 10 from a neutral position. The shift elements SB5 and SB6, however, are designed to be single shift elements, of which the respective coupling element either is in a neutral position or connects the respectively associated idler gear to the respective counter shaft 8 or 10.

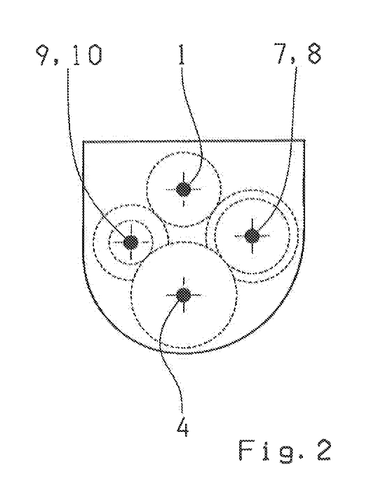

FIG. 2 provides a schematic, front-end view of the parallel shift transmission according to the present invention as in FIG. 1, wherein the relative positions of the drive shaft 1, the output drive shaft 4, and the counter shaft pairs 7 and 8 as well as 9 and 10, located coaxially to each other, are presented from said view. Here, the drive shaft 1 and the output drive shaft 4 are arranged offset to each other, wherein the counter shafts 7 and 8 and the counter shafts 9 and 10 are present on either side of a plane spanned by the drive shaft 1 and the output drive shaft 4. The advantage according to the present invention is illustrated when FIG. 2 is combined with the schematic structure of the transmission illustrated in FIG. 1. This is because the placement of the single clutches 11 and 12 between the counter shafts 7 and 8 or 9 and 10, respectively, of the transmission branches 5 or 6, respectively, makes it possible to readily feed a power take-off of the drive machine of the respective utility vehicle, for example, to drive a power take-off shaft for auxiliary shafts of a tractor, coaxially through the transmission. This requires either that the drive shaft 1 be implemented only extending accordingly in the axial direction or that a coaxial shaft correspondingly connectable to the drive shaft 1 be provided. For systems in which a double clutch is provided in the region of a drive shaft, however, this is associated with a corresponding expenditure, because the coaxial through-drive of the drive machine is fed through the double clutch and therefore, generally, a plurality of hollow shafts must be worked with. With the parallel shift transmission according to the present invention, however, this is feasible with little effort, because both the output drive shaft 4 and the counter shafts 7 to 10 are placed offset to the drive shaft 1.

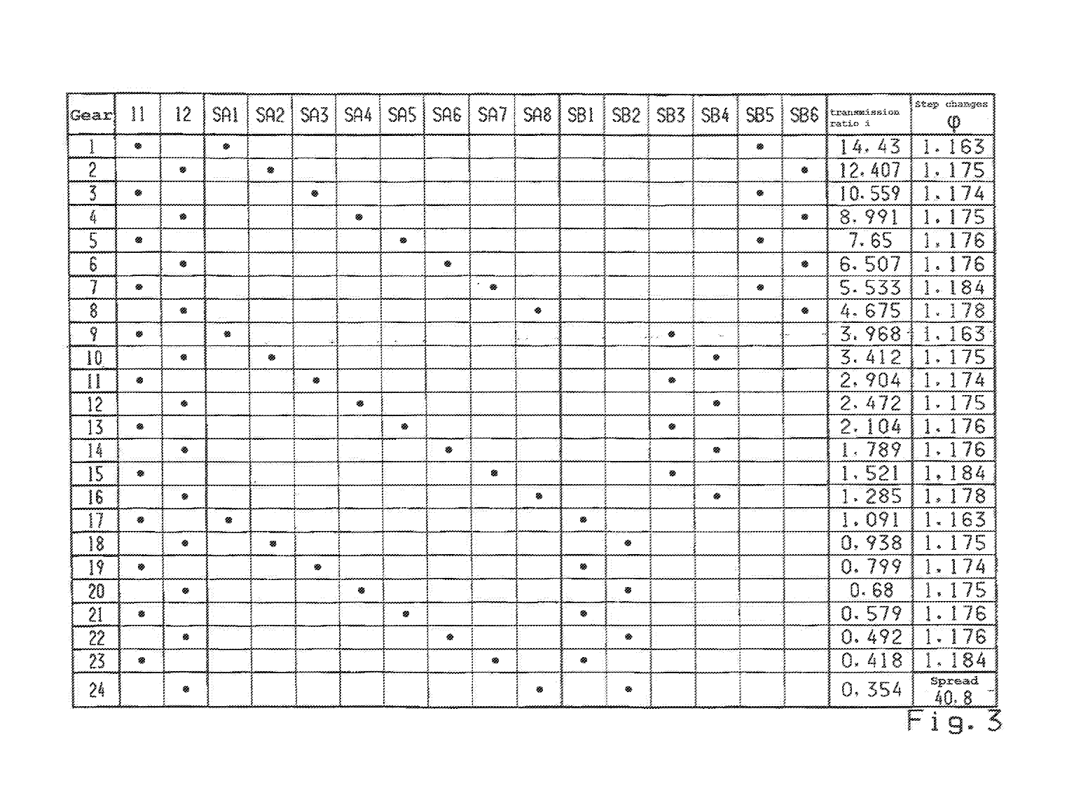

Furthermore, FIG. 3 illustrates a shift matrix of a parallel shift transmission as in FIG. 1, by way of example. As will be understood here, a total of 24 driving gears can be implemented with the parallel shift transmission, wherein a gear change can be carried out under load at all times with a sequential shifting. For this purpose, a subsequent gear is pre-selected in the corresponding unloaded transmission branch 5 or 6 in forward driving in a gear and a power flow via one of the transmission branches 5 or 6 corresponding to an actuation of the respectively associated single clutch 11 or 12, respectively, and subject to the selection of one of the gear stages A1 to A8 in the split group 2 and one of the group stages B1.1 to B3.2 in the range group 3. This entails shifting the gear stage following the current gear stage as well as the current group stage through actuation of the respectively associated shift elements in the currently unloaded transmission branch 5 or 6 and then performing a gear change only by disengaging the one single clutch 11 or 12 and engaging the other single clutch 12 or 11. Upon driving in the last gear stage A8 in the group stages B1.1 to B3.2, the gear stage A1 in the split group 2 and a group stage following the current group stage are again pre-selected in the respective unloaded transmission branch 5 or 6. This procedure can be observed in the shift matrix in FIG. 3. Moreover, FIG. 3 illustrates by way of example transmission ratios i of the single gears and step changes φ between the single gears. It can be seen here that between the single gears, substantially geometric step changes are provided, and a very high spread in the parallel shift transmission according to the present invention can be achieved.

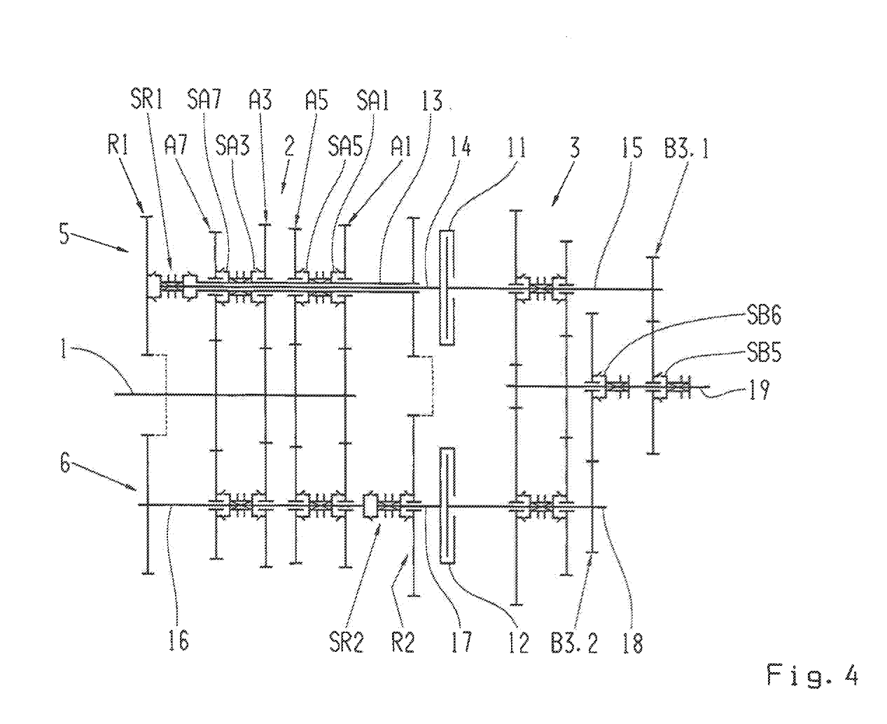

FIG. 4 presents a second preferred embodiment of a parallel shift transmission as in the present invention. By contrast with the previously described variant, two gearwheel pairs R1 and R2 are provided between counter shafts 13, 14, and 15 of the one transmission branch 5 and counter shafts 16, 17, and 18 of the other transmission branch 6, via which gearwheel pairs a reversal in the direction of rotation can be induced in the respective parallel shift transmission. This is achieved by coupling the output side of the split group 2 on the part of one transmission branch 5 or 6 to the drive side of the range group 3 on the part of the other transmission branch 6 or 5, via the respective gearwheel pair R1 or R2. For this purpose, a fixed gear of the gearwheel pair R1 is arranged on the counter shaft 16 of the transmission branch 6, and meshes with an idler gear mounted relative to the counter shaft 14 of the transmission branch 5. Conversely thereto, in the gearwheel pair R2 a fixed gear is provided on the counter shaft 13 of the transmission branch 5 and is in meshed engagement with an idler gear which is rotatably arranged on the counter shaft 17 of the transmission branch 6.

A respective switching element SR1 or SR2, which is implemented as a shift packet, are now assigned to the respective gearwheel pair R1 or R2. A coupling element of the switching element SR1 then connects, from a neutral position, either the idler gear of the gearwheel pair R1 to the counter shaft 14 or the counter shaft 14 to the counter 13 that extends coaxial thereto and is implemented as a hollow shaft depending on the shift position. In the case of the switching element SR2, in displacing a coupling element of the switching element SR2 from the neutral position, either the idler gear of the gearwheel pair R2 is connected to the counter shaft 17, or the counter shaft 17 is coupled to the counter shaft 16 arranged coaxially thereto.

Each of the switching elements SR1 and SR2 thus first assumes the task of connecting the counter shafts 13 and 14 or 16 and 17, respectively, to one another, provided in the respective transmission branch 5 or 6, respectively, in a forward driving operation of the transmission, so that rotary motion of the drive shaft 1 can be transferred to the respective counter shaft 14 or 17, being transmitted with one of the transmission ratios of the split group 2, which counter shaft can then, in the further course, be connected to the respective drive-side counter shaft 15 or 18 of the range group 3 via the single clutches 11 and 12. Otherwise, the one counter shaft 13 or 16 is coupled, via the respective intermediate gearwheel pair R1 or R2, to the counter shaft 17 or 14, respectively, running parallel thereto, thus achieving a reversal in the direction of rotation.

In order to enable connections for all of the gears thereby, the idler gears of the gear stages A1, A3, A5, and A7, with the respectively associated shift elements SA1, SA3, SA5, and SA7, are additionally rotatably supported on the counter shaft 13 that is formed so as to be a hollow shaft. Another difference from the embodiment as in FIG. 1 lies in that the group stage pairs B3.1 and B3.2 are also placed in separate planes in the axial direction, wherein idler gears of the group stage pairs B3.1 and B3.2 are arranged together with the shift elements SB5 and SB6 on an output drive shaft 19.

By means of an embodiment of a parallel shift transmission as in FIG. 4, a reversal in rotational speed with only one additional meshed engagement via the respective gear pair R1 or R2 can thus be represented for all of the forward gears. Due to the placement of the switching elements SR1 and SR2 between the single clutches 11 and 12 and to associated gearwheel pair R1 or R2, this can be effected under load so as to enable a reversing of the respective utility vehicle. Furthermore, displacing the idler gears of the group stage pairs B3.1 and B3.2 together with the shift elements SB5 and SB6 thereof on the output drive shift 19 makes it possible to avoid overly high rotational speeds of the idler gears of the group stage pairs B3.1 and B3.2.

It is additionally conceivable within the scope of the present invention to arrange, in particular, gear stages of the split group 2 with a high transmission ratio, and/or group stages with a high range ratio in the axial direction, on single planes, similar to the group stage pairs B3.1 and B3.2, so that the counter shafts 13 to 15 of the transmission branch 5 and the counter shafts 16 to 18 of the transfer stage 6 are placed closer together and therefore so that gearwheels of the gearwheel pairs R1 and R2 can be made smaller.

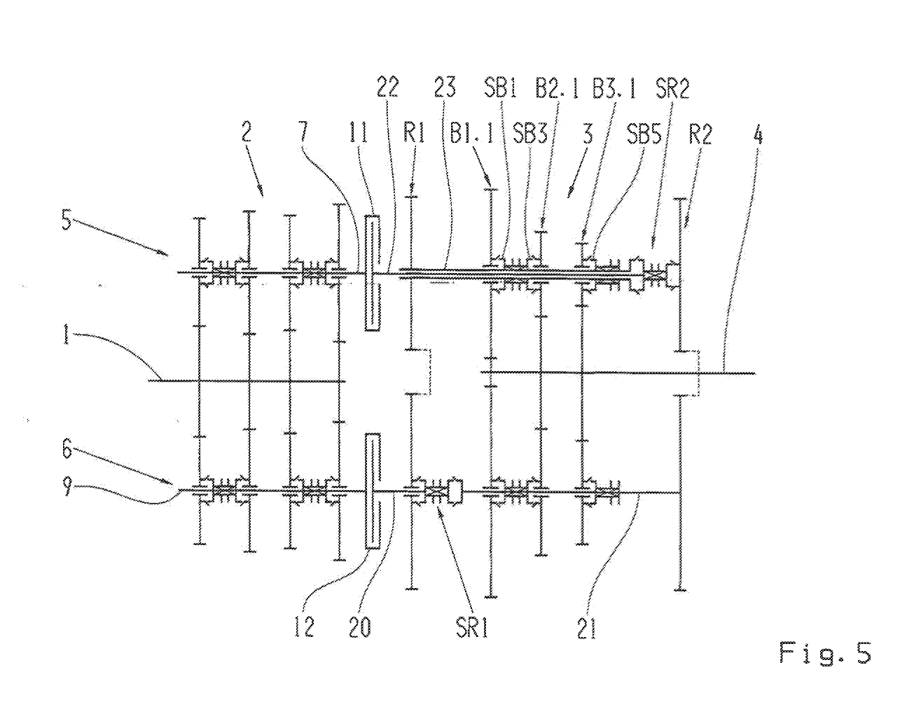

FIG. 5 goes on to depict a third preferred embodiment of a parallel shift transmission as in the present invention. Unlike the embodiment as in FIG. 4, the gearwheel pairs R2 and R2 are placed together with the associated switching elements SR1 and SR2 on the side of the range group 3 in this instance, and constitute an output-side connection of the split group 2 on the part of one transmission branch 5 or 6 to the drive-side of the range group 3 on the part of the other transmission branch 6 or 5 in the direction of the power flow from the drive shaft 1 to the output drive shaft 4 behind the single clutch 11 or 12. The switching element SR1 here connects either an idler gear of the gearwheel pair R1 to a counter shaft 20 of the transmission branch 6 or the counter shaft 20 to a counter shaft 21 that extends coaxially thereto. On the other side, a coupling element of the switching element SR2 either connects the idler gear of the gearwheel pair R2 to a counter shaft 22 of the transmission branch 5 or constitutes a coupling of this counter shaft 22 to a counter shaft 23 that extends coaxially thereto arid is implemented as a hollow shaft. This counter shaft 23 bears herein the idler gears of the group stages B1.1, B2.1, and B3.1, as well as the shift elements SB1, SB3, and SB5 thereof. A further difference lies in that the group stage pairs B3.1 and B3.2 are arranged in an axial plane, as in the embodiment according to FIG. 1.

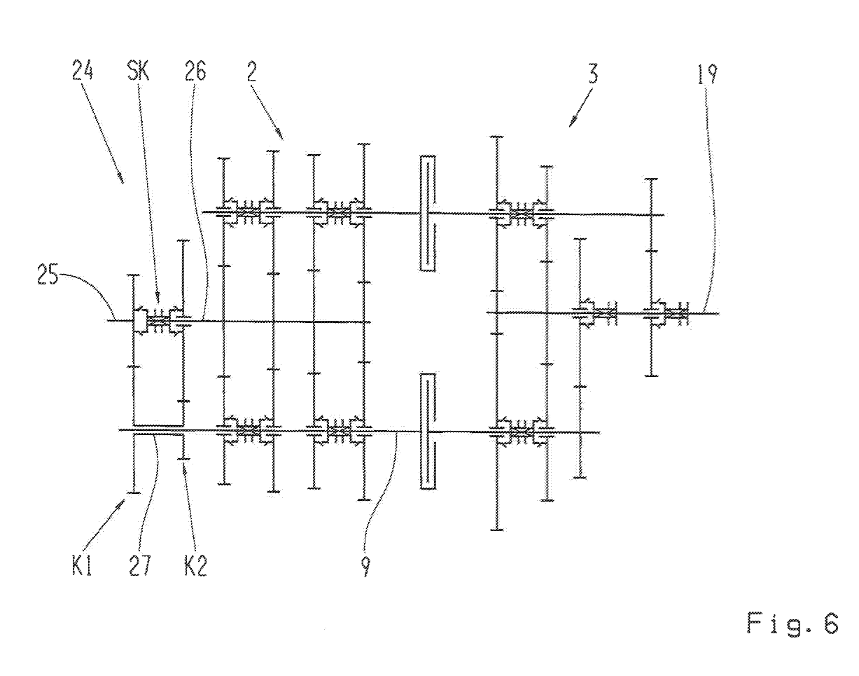

Finally, FIG. 6 portrays a fourth preferred embodiment of a parallel shift transmission as in the present invention. Unlike the embodiment as in FIG. 1, in this instance in addition to the split group and the range group, yet another crawler gear group 24 is provided, by which means rotary motion of a drive shaft 25 can be transmitted via two crawler gear stages K1 and K2 to an output shaft 26 or the crawler gear group 24, wherein the output shaft 26 then in the further course bears the fixed gears of the split group 2. For this purpose, the crawler gear group 24 is provided with a shift packet SK having a coupling element via which, in moving from a neutral position, either the drive shaft 25 can be directly connected to the coaxially extending output shaft 26, or an idler gear that would otherwise be rotatably mounted onto the output shaft 26 is non-rotatably connected to the output shaft 26, so that a power flow takes place over the two crawler gear stages K1 and K2 to the output shaft 26. Herein, a fixed gear of the first crawler gear stage K1 is arranged on the drive shaft 25 and a fixed gear meshing therewith is arranged on a counter shaft 27 extending parallel thereto, which shaft also bears the gearwheel that engages with the idler gear provided on the output shaft 26. The counter shaft 27 is herein arranged coaxially to the counter shaft 9 and is designed as a hollow shaft. As yet another difference, the group stage pair B3.1 and B3.2, as already stated in the embodiment as in FIG. 4, is arranged in the axial direction lying on separate planes and idler gears of the group stage pair B3.1 and B3.2 are rotatably mounted on an output drive shaft 19.

In the embodiments of the present invention described above, corresponding numbers of forward gears and, partially, of reverse gears, can be represented, according to the design of the single groups of the transmission. A person skilled in the art will however readily understand that other numbers of gears can also be realized in accordance with the embodiment of the single groups. In addition, the arrangement of the single gear planes of the split group 2 and/or the range group 3 in the axial direction, and thus for the gear stages A1 to A8 and the group stages B1.1 to B3.2, can also be changed.

It is additionally conceivable within the scope of the present invention to design the shift elements, as well as the switching elements in any form, as clutches, but preferably as form-locking clutches in the form of locking synchronizations or claw clutches. Here it is also conceivable to design one portion of the shift elements as locking synchronizations and the other portion as centrally synchronized claw clutches. In this context, a central synchronizing unit, for example, in the form of a multi-disc brake or a band brake, can be provided on the respective shafts, via which synchronizing unit the corresponding synchronous speed is represented by using a claw clutch. Moreover, in principle, an electric machine or other energy/power source can be arranged on any shaft, wherein this is preferably to be provided on the drive shaft. Instead of the above-mentioned central synchronization in the form of a multi-disc brake, it would also be possible to provide, in each case, an electrical machine, which then takes over the task of the central synchronization.

The crawler gear group 24 provided in the embodiment as in FIG. 6 can be provided in an analogous manner as well on the part of the output drive shaft 19, wherein the crawler gear group then is connected to the output side of the range group 3 on the part of the input drive, and the output drive shaft is provided instead of the output shaft 26.

By means of a parallel shift transmission according to an embodiment of the present invention, therefore, it is possible to feed a power take-off of a drive machine of a respective utility vehicle through the transmission with little effort. The placement of the single couplings in the reduction gears of the transmission branches also makes it possible to achieve low mass inertias in the reduction gears. Furthermore, the single embodiments are distinguished by high numbers of load-shiftable gears, very favorable gear-meshing efficiency, low component loads, and a favorable capability for direct shifting. Depending on the arrangement of the single stages of the split group and the range group, a very short construction can be obtained in the axial direction as well.

### REFERENCE SYMBOLS

1 Drive shaft
2 Split group
3 Range group
4 Output drive shaft
5 Transmission branch
6 Transmission branch
7 Counter shaft
8 Counter shaft
9 Counter shaft
10 Counter shaft
11 Single clutch
12 Single clutch
13 Counter shaft
14 Counter shaft
15 Counter shaft
16 Counter shaft
17 Counter shaft
18 Counter shaft
19 output drive shaft
20 Counter shaft
21 Counter shaft
22 Counter shaft
23 Counter shaft
24 Crawler gear group
25 Drive shaft
26 Output shaft
27 Counter shaft
A1-A8 Gear stages
SA1-SA8 shift elements
B1.1-B3.2 Group stages
SB1-SB6 shift elements
R1, R2 Gearwheel pairs
SR1, SR2 Switching elements
K1, K2 Crawler gear stages
SK Shift packet

1-10. (canceled)

11. A parallel shift transmission for a motor vehicle, the parallel shift transmission comprising:
a split group (2);
a range group (3);
each of the split group (2) and the range group (3) being divided into two parallel transmission branches (5, 6);
one of the transmission branches (5, 6) being selectable by actuating one respectively corresponding load shift element so that rotational movement of a drive shaft (1; 25) is transferred, via one of a plurality of transmission ratios of the split group (2), to countershafts (7 to 10; 13 to 16; 7, 9, 20, 21, 22, 23) according to the selection of one of the transmission branches (5, 6) so that the rotational movement of the drive shaft is converted and transmitted, via one of a plurality of range ratios of the range group (3), into rotational movement of an output drive shaft (4; 19);
each of the transmission ratios is defined by shifting a correspondingly associated gear stage of a plurality of gear stages (A1 to A8) of the split group (2), which are alternately distributed to the two transmission branches (5, 6) in a sequence of the corresponding transmission ratio, and each of the range ratios is set by shifting a correspondingly associated group stage of a plurality of group stages (B1.1 to B3.2) of the range group (3); and
the load shift elements being designed as individual clutches (11, 12), each of which is arranged in the associated transmission branch (5, 6) between an output-side counter shaft (7, 9; 14, 17) of the split group (2) and a drive-side counter shaft (8, 10; 15, 18; 20, 22) of the range group (3).

12. The parallel shift transmission according to claim 11, wherein the gear stages (A1 to A8) of the split group are arranged pairwise in one plane, in an axial direction, by assigning a shared fixed gear to a gear stage (A1, A3, A5, A7) associated with one transmission branch (5) and to a gear stage (A2, A4, A6, A8) that is adjacent and assigned to the other transmission branch (6).

13. The parallel shift transmission according to claim 11, wherein at least gear stages of the split group (2) are placed individually in one plane in an axial direction with a respective high transmission ratio.

14. The parallel shift transmission according to claim 11, wherein respective gearwheel pairs, of at least one group stage (B1.1 to B3.2) of the range group (3), are arranged in a common plane in an axial direction for the two transmission branches (5, 6), and a common fixed gear is assigned to the gearwheel pairs.

15. The parallel shift transmission according to claim 11, wherein respective gearwheel pairs of at least one group stage (B3.1, B3.2) are placed separately, on a respective plane in an axial direction, for each of the transmission branches (5, 6).

16. The parallel shift transmission according to claim 15, wherein idler gears of the gearwheel pairs are arranged on the output drive shaft (19).

17. The parallel shift transmission according to claim 11, wherein parallel counter shafts (13, 14, 16, 17; 20, 21, 22, 23) are coupled to one another, via individual gearwheel pairs (R1, R2) through actuation of associated switching elements (SR1, SR2), in such a manner that a counter shaft (13; 16; 20; 22) of which transmission branch (5; 6) on an output side of the split group (2) is connected to a parallel counter shaft (17; 14; 23; 21) of the other transmission branched (6; 5) on a drive side of the range group (3) for a reversal in direction of rotation.

18. The parallel shift transmission according to claim 11, wherein parallel shift transmission further comprises a crawler gear group (24) by which rotary motion is transmittable from an input shaft, via a first crawler gear stage (K1), to a parallel counter shaft (27) and from a reduction gear shaft (27) to an output shaft (26), via a second crawler gear stage (K2).

19. The parallel shift transmission according to claim 18, wherein the crawler gear group (24) comprises a shift packet (SK), via which either an input shaft is couplable directly to the output shaft (26) running coaxially to the input shaft, or a power flow can be realized via the two crawler gear stages (K1, K2).

20. The parallel shift transmission according to claim 18, wherein the input shaft is the drive shaft (25) or the output shaft is the output drive shaft.

21. A parallel shift transmission for one of an agricultural and a municipal utility vehicle, the parallel shift transmission comprising:
a split group and a range group, each of the split group and the range group comprising first and second countershafts,
the first countershafts of the split group and the range group being coaxially aligned with one another and defining a first transmission branch, and the second countershafts of the split group and the range group being coaxially aligned with one another and defining a second transmission branch, and the first and the second transmission branches extending parallel to one another;
each of the first and the second transmission branches comprising a clutch that is located between the split group and the range group, the first countershaft of the split group being connectable, via the clutch of the first transmission branch, to the first countershaft of the range group, and the second countershaft of the split group being connectable, via the clutch of the second transmission branch, to the second countershaft of the range group, and only one of the clutches of the first and the second transmission branches being engagable at a time for transmitting rotation from an input shaft to a output shaft along one of the engaged first or second transmission branches;
the split group comprising a plurality of gear stages and each one of the gear stages of the split group defining two gear ratios and comprising gearwheels that engage each other and are supported by the input shaft, the first and the second countershafts of the split group, the gear ratios of the split group being arranged alternately on the first and the second countershafts of the split group in sequence in an axial direction;
the range group comprising a plurality of gear stages and each one of the gear stages of the range group defining two gear ratios and comprising gearwheels that engage each other and are supported by the output shaft, the first and the second countershafts of the range group, the gear ratios of the range group being arranged alternately on the first and the second countershafts of the range group in sequence in an axial direction; and
a plurality of transmission ratios being sequentially engagable by engagement of corresponding gear ratios of the split group and the range group and alternate engagement of the clutches of the first and the second transmission branches.
